(19) United States
(12) Patent Application Publication
(10) Pub. No.: US 2025/0315501 A1
(43) Pub. Date: Oct. 9, 2025

(54) Computer-Implemented Method for Reducing Computing Time when Determining an Inverse Matrix from a Symmetrical Input Matrix

(71) Applicant: Robert Bosch GmbH, Stuttgart (DE)

(72) Inventor: Simon Weissenmayer, Flein (DE)

(21) Appl. No.: 19/089,473

(22) Filed: Mar. 25, 2025

(30) Foreign Application Priority Data
Apr. 5, 2024 (DE) 10 2024 203 136.4

(51) Int. Cl. G06F 17/16

(52) U.S. Cl. CPC G06F 17/16

(57) ABSTRACT

A computer-implemented method is for reducing computing time when determining an inverse matrix from a symmetrical input matrix comprising n rows and n columns. The method includes forming i blocks with mᵢ rows and mᵢ columns, with mᵢ less than n and i being greater than or equal to 2. The i blocks are each formed from entries of main diagonals which are most strongly correlated and mᵢ entries of secondary diagonals in the same rows and columns as the entries of the main diagonals. The method further includes generating a block diagonal matrix from the i blocks, and generating the inverse matrix to the input matrix by inverting the blocks in the block diagonal matrix.

This application claims priority under 35 U.S.C. § 119 to patent application no. DE 10 2024 203 136.4, filed on Apr. 5, 2024 in Germany, the disclosure of which is incorporated herein by reference in its entirety.

The disclosure relates to a computer-implemented method for reducing the computing time required to determine an inverse matrix. The disclosure thus relates to the field of computer-aided matrix inversion, as required, for example, when using Kalman filters.

### BACKGROUND

The covariance matrix, also known as a variance-covariance matrix or occasionally a dispersion matrix, generalizes in stochastics the variance of a one-dimensional random variable to a multidimensional random variable, namely a random vector. The diagonal elements of the covariance matrix correspond to the individual variances, while all other elements represent the covariances.

The Kalman filter is a mathematical tool for the step-by-step estimation of parameters that describe the system states of a system. The filter makes it possible to estimate quantities that cannot be measured directly, while at the same time attempting to minimize errors in the measurements.

By integrating mathematical models as a constraint, dynamic aspects can also be taken into account. For example, motion equations can be used to accurately estimate the positions and velocities of moving objects.

The special mathematical structure of the Kalman filter makes it suitable for use in real-time systems in a range of technical applications. These range from tracking moving objects using radar signals or GNSS data to controlling electronic systems such as radios or mobile phones, as well as managing electric bicycles.

Covariance matrices play a central role in the use of Kalman filters. When fusing two multidimensional correlated Gaussian processes, matrix inversion is often performed. This inversion can take a long computing time, especially when there are a large number of dimensions (>>3) and thus large covariance matrices.

A new corrected or fused covariance matrix can be calculated from the previous covariance matrix P_{K}⁻ using the Kalman gain with

$${P}_{k} = ( I - {K}_{k} {H}_{k} ) {P}_{k}^{-}$$

Here, is the identity matrix and is the observation matrix. The Kalman gain Kₖ is previously calculated from a quotient whose denominator consists of the sum of the previous covariance matrix P_{K}⁻ and the covariance matrix P_{K} of the measurement noise.

$${K}_{k} = \frac{{P}_{k}^{-} {H}_{k}^{T}}{{H}_{k} {P}_{k}^{-} {H}_{k}^{T} + {R}_{k}} .$$

The formation of this quotient can take a great deal of computational time for large matrices.

From Ambikasaran et al, “Fast Direct Methods for Gaussian Processes”, 2015, we know how a matrix to be inverted is first decomposed into a product of several matrices in order to then perform the inversion with significantly less computing time. The factor matrices have zero matrices in the secondary diagonals. The loss of accuracy results from the generation of low-rank secondary diagonal matrices. However, the generation of low-rank secondary diagonal matrices is complex and therefore takes a long time to compute.

The disclosure is thus based on the problem of proposing a method that reduces the computing time required to form an inverse of a matrix, wherein the loss of accuracy with respect to conventional matrix inversion is minimized.

The task is solved according to the disclosure.

### SUMMARY

According to the first aspect of the disclosure, this task is solved by a computer-implemented method for reducing computing time when determining an inverse matrix from an symmetrical input matrix comprising n rows and n columns.

The method comprises the steps of:
forming i blocks with mᵢ rows and mᵢ columns, wherein mᵢ is less than n and wherein i is greater than or equal to 2, wherein the i blocks are each formed from the entries of the main diagonals which are most strongly correlated and mᵢ entries of the secondary diagonals in the same rows and columns as the entries of the main diagonals;
generating a block diagonal matrix from the i blocks; and
generating an inverse matrix to the input matrix by inverting the blocks in the block diagonal matrix.

The disclosure exploits the fact that the inverse of a block diagonal matrix is again a block diagonal matrix consisting of the inverse of the individual blocks. The input matrix is therefore first converted into a block diagonal matrix to which this criterion applies.

A block matrix is a special form of a matrix in which the individual elements can be not only simple numbers, but also matrices, so-called blocks. These blocks are usually displayed in a rectangular array, wherein the dimensions of the blocks are chosen so that the block matrix retains a rectangular shape. A block diagonal matrix is in turn a special type of block matrix in which the non-zero blocks are only on the main diagonal, while all other blocks are zero.

The number i of blocks depends on the size of the input matrix. The larger the input matrix, the more blocks it can be decomposed into for maximum effect of the disclosure. The number of blocks i is greater than 2, since a block matrix with only one block would be identical to the input matrix and the method would therefore have no advantage.

The size of the blocks can be uniform, so that mᵢ is the same for each block i. Alternatively, blocks of different sizes can be used, so that mᵢ is not always the same and is different for each block. In either case, the blocks each have the same number of rows and columns, so that they are square matrices.

The secondary diagonal of the block matrix is zero. This represents a simplification of the input matrix, since the entries on the secondary diagonal in the input matrix are often very small but rarely equal to zero. The inverse generated is therefore an approximation of the mathematically correct inverse of the input matrix, which is, however, sufficient for the purpose of a Kalman gain. This is particularly the case when the computing time for determining this inverse is taken into account.

The block diagonal matrix can be generated in such a way that the blocks on the main diagonal do not exceed a certain size, for example 1×1, 2×2 or 3×3, and in special cases 4×4, 5×5 or 6×6. By creating block diagonal matrices with very small blocks, the computing power required to invert the matrix can be drastically reduced, because the computing power required for fully populated matrices is roughly halved with each reduced dimension, while the error that occurs is relatively small. Decomposing a 10×10 matrix into a block diagonal matrix with two 2×2 and two 3×3 block matrices and then inverting it requires only slightly more than 2% of the computing power required to invert the 10×10 matrix.

The blocks are determined from entries in the input matrix that are matrices strongly correlated. The correlation strength can be determined, for example, using the absolute value of the Pearson correlation factor.

Once the block diagonal matrix has been formed, the individual blocks can be inverted with considerably less computing time than the entire input matrix. Overall, this can reduce the computing time required for the computer-implemented determination of an inverse matrix, which solves the problem of the disclosure.

In one embodiment, the determination of the most matrices strongly correlated entries for forming of the i-th block comprises:
determining the largest entry in terms of amount in the secondary diagonals and determining the next largest mᵢ−2 entries in terms of amount in the same row of the largest entry in terms of amount, if mᵢ−2 is greater than zero in terms of amount, wherein the entries thus determined in this row are the first entries, or
determining the largest sum of the amounts of the mᵢ−1 entries within a line in the secondary diagonals, wherein these largest mᵢ−1 entries in terms of amount are the first entries;
assigning the first entries to two entries of the main diagonal, wherein one of the entries of the main diagonal is the entry in the same row and wherein the other of the entries of the main diagonal is the entry in the same column;
determining second entries, wherein the second entries are the entries in the columns of the first entries and in the rows of the main diagonals associated with the first entries; and
selecting the first entries, the second entries, the symmetrical entries in the respective mirrored secondary diagonals and the entries on the main diagonal and setting the remaining entries in the columns and rows of the first entries, the second entries and the entries assigned to the first entries on the main diagonal to zero, wherein further blocks are formed from the entries that are not zero and wherein the preceding steps are repeated for each of these blocks.

The entries of the secondary diagonal of the input matrix reflect how strongly the entries of the main diagonal correlate with each other in the respective row and in the respective column. A high entry in a secondary diagonal close to 1 indicates that the entries of the main diagonal in the same column and the same row are strongly correlated. If the entry is close to zero, the two main diagonal entries are not correlated or are only very slightly correlated. For very small values close to −1, there is a negative correlation between the main diagonal values.

In the first step to determine the most strongly correlated entries, the strongest correlation, i.e. the largest value of the secondary diagonal, is determined. A single largest entry is then determined as the single first entry if mᵢ=2 or mᵢ−1=1. In other words, a single value is determined if the block formed is a 2×2 matrix.

If the block to be formed is larger, for example a 3×3 or 4×4 matrix, several values must be determined that are most strongly correlated. There are at least two ways of doing this.

The first option is to determine the largest entry from all the entries in the secondary diagonal and to use the mᵢ−2 next largest entries to create the mᵢ×mᵢ large block. This means that block i contains the most strongly correlated mᵢ−1 entries of the secondary diagonal within a row of the input matrix. These rows are no longer available for the other blocks. In this way, the blocks are ordered according to the most strongly correlated entries of the main diagonal.

The second option involves calculating the sums of mᵢ−1 entries in each row and selecting the row in which the largest sum is found. The main diagonal entry in the same row and the main diagonal entries in the columns of the entries added for this sum form the most strongly correlated entries in this option. This option for determining the most strongly correlated entries is more complex than the first option. However, it takes into account the correlation between several parameters and is therefore more accurate.

This can be illustrated with an example: Given is a 6×6 matrix A, which is to be decomposed into two 3×3 blocks. The rows and columns of matrix A are numbered from top to bottom and from left to right, respectively.

$$A = ( \begin{matrix}1 & 1 & 1 & 4 & 1 & 4 \\ 1 & 2 & 1 & 5 & 2 & 1 \\ 1 & 1 & 3 & 3 & 1 & 4 \\ 4 & 5 & 3 & 1 & 3 & 1 \\ 1 & 2 & 1 & 3 & 2 & 2 \\ 4 & 1 & 4 & 1 & 2 & 3\end{matrix} )$$

The largest entry in the secondary diagonal is determined first. This is 5 in the second row and the fourth column. The second largest entry in the same row is 2 in the fifth column. These two entries form the first entries. The first entries are assigned to the entries whose row number matches the column number of the first entries. That is, the 5 in the fourth column is matched with the 1 on the main diagonal in the fourth row. The 2 in the fifth column is matched with the 2 on the main diagonal in the fifth column. It is also matched with the entry on the main diagonal of the same row as the first entry.

Next, the second entries are determined. These are the entries that are in the same columns as the first entries and the rows of the corresponding entries on the main diagonal. In the example, for the first entry 5 in the fourth column, this would be the 3 in row five. For the other first entry 2 in the fifth column, this would be the 3 in the fourth row.

The remaining entries in the columns and rows of the first entries, the second entries and the assigned entries on the main diagonal are set to zero. This means that in the second, fourth and fifth columns, as well as in the second, fourth and fifth rows, all entries=0 that are not the first entries, the second entries or the entries on the main diagonal.

$${A}_{null , 1} = ( \begin{matrix}1 & 0 & 1 & 0 & 0 & 4 \\ 0 & 2 & 0 & 5 & 2 & 0 \\ 1 & 0 & 3 & 0 & 0 & 4 \\ 0 & 5 & 0 & 1 & 3 & 0 \\ 0 & 2 & 0 & 3 & 2 & 0 \\ 4 & 0 & 4 & 0 & 0 & 3\end{matrix} )$$

The second block is then formed by the remaining non-zero entries. The block matrix A′ would then look as follows, reorganized in this way, wherein the rows and columns of each block are combined.

$${A}^{′} = ( \begin{matrix}\begin{matrix}2 & 5 & 2 \\ 5 & 1 & 3 \\ 2 & 3 & 2\end{matrix} & 0 \\ 0 & \begin{matrix}1 & 1 & 4 \\ 1 & 3 & 4 \\ 4 & 4 & 3\end{matrix}\end{matrix} )$$

For larger matrices, the above procedure can be repeated until there are no more entries.

If matrix A″ were created with the second option described, it would look different. In this case, the largest sum of two entries within a column would be formed, which then defines the first block. The entries in the fourth and sixth columns in the third row form the largest sum with 3+4=7. Matrix A″ would therefore look like this.

$${A}_{null , 2} = ( \begin{matrix}1 & 1 & 0 & 0 & 1 & 0 \\ 1 & 2 & 0 & 0 & 2 & 0 \\ 0 & 0 & 3 & 3 & 0 & 4 \\ 0 & 0 & 3 & 1 & 0 & 1 \\ 1 & 2 & 0 & 0 & 2 & 0 \\ 4 & 1 & 4 & 1 & 0 & 3\end{matrix} ) ; {A}^{″} = ( \begin{matrix}\begin{matrix}3 & 3 & 4 \\ 3 & 1 & 1 \\ 4 & 1 & 3\end{matrix} & 0 \\ 0 & \begin{matrix}1 & 1 & 1 \\ 1 & 2 & 2 \\ 1 & 2 & 2\end{matrix}\end{matrix} )$$

For blocks of size 2×2, the next larger entries would be determined for the first possibility mᵢ−2=0, which is of course not possible. For the second possibility, a sum of mᵢ−1=1 entries would be formed, which is equivalent to determining the largest entry. Determining the second entries is not necessary for blocks of this size.

This embodiment has the advantage of optimizing and simplifying the formation of blocks. Furthermore, the complexity of calculating an inverse matrix does not depend on the values of the entries, but on the number of entries. The proposed embodiment takes into account the entries that have a particularly high correlation with each other. Entries with low correlations, on the other hand, are neglected in favor of increased computing speed.

In one embodiment, mᵢ is determined dynamically, wherein mᵢ is initially 2 and is determined using the following steps:
determining the largest entry of the secondary diagonals;
1 determining the row y of the input matrix in which the largest entry is located; and
determining the next smaller entry within row y from the secondary diagonals and increasing mᵢ by 1 for each next smaller entry in row y that fulfills a criterion for the strength of the correlation.

The criterion of the strength of a correlation indicates a relationship between two entries from a row. For example, if a first value A has a correlation with a second value B of >0.9 and at the same time A has a correlation with a third value C of >0.85, then it is obvious that B and C are also strongly correlated. In this case, it may be useful to combine the three values A, B and C into one block. Mᵢ would then be 3.

The criterion of the strength of the correlation can include fixed rules for this. These rules can, for example, be that the difference or the ratio of two correlation values must not exceed or fall below a threshold value. Furthermore, a scale can be used in which all correlation values above a first threshold form the first block, all correlation values above a second threshold form the second block, and so on.

According to this embodiment, the method can be used particularly advantageously when the correlation strength between the entries cannot be estimated in advance and the block size cannot be determined. This may be the case, for example, when the input matrix represents a system state, new sensors are used to measure new parameters, and the correlation of the new parameters with the measured values of existing sensors cannot be estimated.

This advantageous embodiment also allows several entries from the input matrix to be combined into a block if necessary, if the criterion of the strength of the correlation allows this.

In one embodiment, mᵢ is less than or equal to a defined limit block size.

In particular, when the method with dynamic block sizes is used, the maximum block size should be limited. The larger the blocks, the more expensive it is to determine the inverse of these blocks. For example, if a 7×7 matrix is decomposed into a 6×6 block and a block comprising a single entry, the beneficial effect of the disclosure is less than if the same matrix were decomposed into a 3×3 block and two 2×2 blocks. This is due to the fact that the effort required to determine the inverse of a matrix does not increase linearly with the size of the matrix, but exponentially.

It is advantageous to reduce the computing time required to determine the inverse of the blocks by limiting the block size. Preferably, the limit block size is 6, more preferably 3 or 2. The smaller the block size, the faster the inverse of the block can be determined and the greater the effect achieved by the disclosure.

In one embodiment, the input matrix is associated with a system state having a plurality of parameters and the system state is based on a physical model, wherein the physical model describes a physical correlation between the parameters, wherein mᵢ is determined according to the physical correlation between the parameters.

The system state describes the state of a technical system, for example a production plant, a tool or a vehicle. Each recorded value, for example the current speed of the vehicle, the speeds of the individual wheels, the engine speed, the temperature, the pressure in the fuel or hydraulic lines, the voltages of the batteries or electric motors, etc., can be represented by a dimension in the input matrix. The more complex the technical system, the more comprehensive the system state represented by the input matrix can be.

In technical systems, there is usually a technical connection between some parameters because individual components of the system interact with each other. In a vehicle, for example, the speeds of individual wheels are connected with each other by the fact that, ideally, all four wheels roll on the same road surface and move with the vehicle. Deviations from this can indicate particularly high slip, for example. In another case, the position of a working system, for example an excavator shovel, and the pressure in the corresponding hydraulic lines are coupled to each other.

The technical system is therefore based on a physical model that describes the technical relationships of the system. Correlations between individual parameters can be derived from this model and used in the present method. Not only can a size mᵢ be estimated for the blocks to be formed in the input matrix, but under certain circumstances the columns whose entries on the main diagonal are to form blocks with one another can also be defined.

This embodiment advantageously takes into account the technical interaction of the system represented by the input matrix during block formation, which increases the accuracy of the determined inverse.

In one embodiment, the method can be used to recognize the relationship between measured values of two time series. In this embodiment, two time series with the same number of measurement values are represented in a matrix. Each entry of the matrix corresponds to a calculation of a measurement value of one time series with a measurement value of the other time series. For example, the measurement values can be added, multiplied, subtracted or convolved with each other.

The blocks then make it easy to see which measured values correlate particularly strongly with each other and which do not.

In a further aspect, the disclosure relates to a computer-implemented method for determining a Kalman gain for a Kalman filter, wherein the determination of the Kalman gain comprises the inversion of at least one n×n matrix, wherein the at least one n×n matrix is inverted as an input matrix using a method as described above.

A Kalman filter can be used to predict a system state of a technical system or to estimate it for the future. This is particularly relevant for systems that have to react to their environment in order to interact in or with it. For example, an autonomous vehicle must not only perceive its environment for its own control, but must also be able to predict the movement of road users detected in it.

Estimating the system state is also important for monitoring systems. Errors or faults can be detected much earlier when considering several parameters together than if only a single parameter were monitored. This makes it possible, for example, to maintain the system more efficiently or to repair it at an early stage before a defect causes damage.

To use the Kalman filter, the Kalman gain must be determined. This in turn requires the quotient of two matrices to be determined, which in turn requires the determination of an inverse matrix.

The proposed method can be used to advantage to reduce the computing resources required for the inversion or to shorten the computing time. The input matrix is broken down into blocks, and the inverse of each block is then formed.

Since the Kalman filter can be used in particular to make a prediction about a system state, it is sufficient if this state is estimated with less precision than if it were done with a mathematically exact inverted matrix. In this case, a reduction in estimation accuracy is accepted in favor of estimation speed.

In one embodiment, the entries of the main diagonal of the input matrix are each assigned to a system state of a technical system, wherein each column comprises a different system parameter and

wherein the entries in the secondary diagonals quantify the correlation between the system parameters assigned to the entries of the main diagonals in the respective row and the respective column.

The input matrix does not necessarily have to include the parameters of the system state. In the context of this embodiment, further operations, in particular convolutions or multiplications with other matrices or system states, can also be performed before applying the method proposed here. The term “assignment” is therefore to be understood as meaning that the system state is represented in some form by the input matrix and that the entries of the matrix can be traced back to the parameters of the system state.

In one embodiment, the behavior of the system parameters and/or a future system state are estimated using the Kalman filter.

In one embodiment, the system state is the state of a vehicle, a position sensor, an inertial sensor or an ultrasonic sensor.

In a further consideration, the disclosure relates to a computer program having program code for performing a method as described above when the computer program is executed on a computer.

In a further consideration, the disclosure relates to a computer readable disk having program code of a computer program for performing a method as described above when the computer program is executed on a computer.

In another aspect, the disclosure relates to a system for determining a Kalman gain for a Kalman filter, wherein the system is configured to carry out a method as described above.

Overall, a method for reducing the computing time required to determine an inverse matrix, a method for determining a Kalman gain for a Kalman filter, a computer program with program code, a computer-readable data carrier with program code and a system for determining a Kalman gain for a Kalman filter are thus specified.

The described embodiments and refinements may be combined with one another as desired.

Further possible embodiments, refinements and implementations of the disclosure also include combinations of features of the disclosure described previously or below with regard to the exemplary embodiments that are not explicitly mentioned.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the advantages mentioned are shown in the drawings. The illustrated elements of the drawings are not necessarily shown to scale with respect to one another.

### The Figures Show:

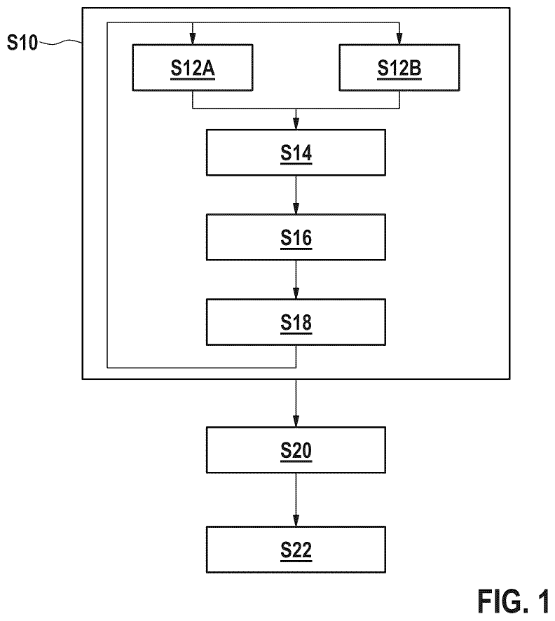

FIG. 1 schematically, the process flow of the method according to one embodiment;

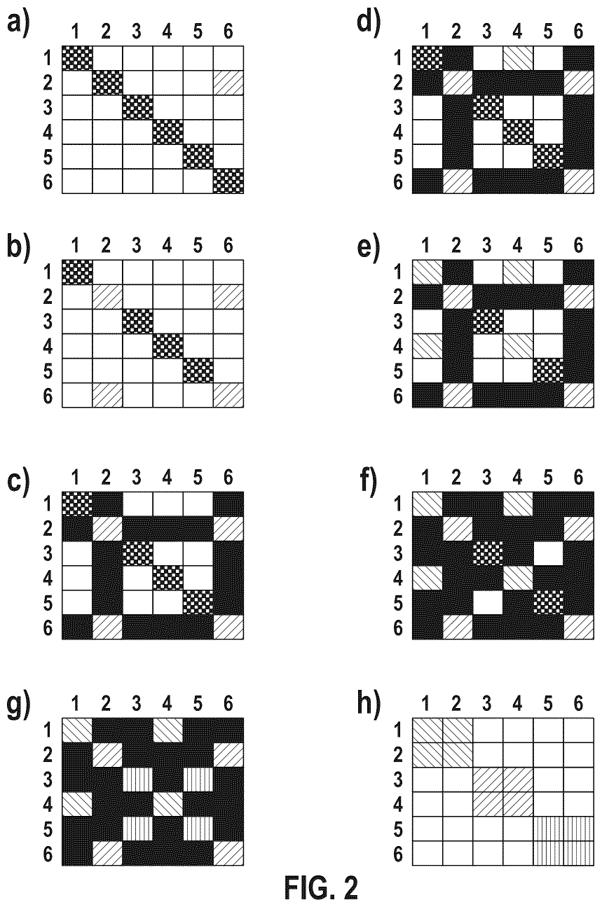

FIGS. 2a) to h) shows the procedure described in FIG. 1 step by step using an example matrix; and

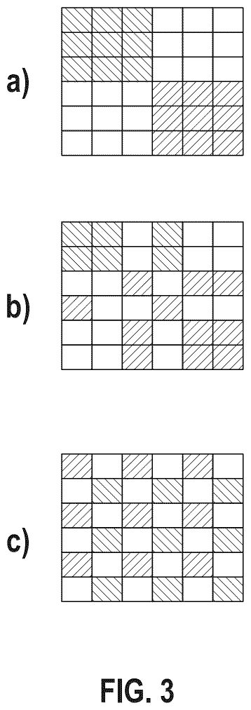

FIGS. 3a) to c) various arrangements of entries from which blocks can be formed.

### DETAILED DESCRIPTION

In the figures of the drawings, identical reference numbers denote identical or functionally identical elements, parts or components, unless stated otherwise.

FIG. 1 schematically shows the sequence of a method according to one embodiment. At the same time, the method with the exemplary matrices shown in FIGS. 2a) to h) is described below.

The method begins with step S10, in which several sub-steps are carried out. First, the largest entries in the secondary diagonals of the input matrix are determined in step S12a or S12b. Steps S12a and S12b represent two alternative methods by which the largest entries can be determined if the size of the blocks to be formed is greater than two.

FIG. 2a shows an example of a 6×6 matrix. The elements of the main diagonal are marked with a checkerboard pattern. The blocks to be formed for this matrix should be 2×2 in size, so that only one entry has to be determined as the largest entry in the secondary diagonals. Since the input matrix is a symmetrical matrix, the search for the largest entry can be limited to one half of the secondary diagonal elements. In this illustrated case, the largest entry is searched for in the upper right half.

The entry in column 6 and row 2, (6, 2) for short, is determined as the largest entry. This entry is called the first entry.

In the next step S14, the first entries, if there are several, are each assigned to two entries on the main diagonal. The first of these two entries is in the same row as the first entry just found. In FIG. 2b) this corresponds to the entry (2, 2). The other entry of the main diagonal is the entry whose row number corresponds to the column number of the first entry. In FIG. 2b) this corresponds to the entry (6,6).

In step S16, the entries designated as the second entries are determined. The second entries are the entries that are in the columns of the first entries and in the respective rows of the entries that are on the main diagonal and associated with the first entries. For 2×2 blocks, this step can be omitted since only a first entry has been determined. The step is therefore only relevant for larger blocks.

Next, in step S18, the remaining entries in the columns and rows of the first entries, the second entries and the entries on the main diagonal are set equal to zero. In FIG. 2 c), this is indicated by a black fill. Columns 2 and 6 as well as rows 2 and 6 are affected.

The substeps of step S10 are now repeated for the next blocks until all entries are either part of a block or zero. This is shown in FIGS. 2d) to f).

In FIG. 2d), entry (4, 1) has been determined as the next largest entry. Entries (1, 1) and (4, 4) on the main diagonal are assigned to this, as shown in FIG. 2e). Finally, the entries in rows 1 and 4 and in columns 1 and 4 are set to zero, as they have not been determined. In FIG. 2f) four entries now remain, which are assigned to the last block, as shown in FIG. 2 g).

The blocks formed in this way are converted into a block diagonal matrix in step S20. To do this, the entries are resorted in blocks. The resorted block diagonal matrix for the example is shown in FIG. 2h), wherein the empty entries are all zero.

The inverse of this block diagonal matrix can be calculated in step S22.

FIGS. 3a), 3b), and 3c) show three examples of 6×6 matrices, each of which is divided into two 3×3 blocks. The entries of the blocks can each be resorted to the form shown in FIG. 3a). Here it can be seen that more than one entry has been determined in each row and consequently in each column.

What is claimed is:

1. A computer-implemented method for reducing computing time when determining an inverse matrix from a symmetrical input matrix comprising n rows and n columns, the method comprising:
forming i blocks with mᵢ rows and mᵢ columns, wherein mᵢ is less than n and wherein i is greater than or equal to 2, wherein the i blocks are each formed from entries of main diagonals which are most strongly correlated and mᵢ entries of secondary diagonals in the same rows and columns as the entries of the main diagonals;
generating a block diagonal matrix from the i blocks; and
generating the inverse matrix to the symmetrical input matrix by inverting the blocks in the block diagonal matrix.

2. The computer-implemented method according to claim 1, wherein determining the most strongly correlated entries for forming the i-th block comprises:
(i) determining a largest entry in terms of amount in the secondary diagonals and determining a next largest mᵢ−2 entries in terms of amount in a same row of the largest entry in terms of amount, when mᵢ−2 is greater than zero in terms of amount, wherein the entries thus determined in this row are the first entries, or (ii) determining a largest sum of the amounts of the mᵢ−1 entries within a line in the secondary diagonals, wherein the largest mᵢ−1 entries in terms of amount are the first entries;
assigning the first entries to two entries of the main diagonal, wherein one of the entries of the main diagonal is the entry in the same row and wherein the other of the entries of the main diagonal is the entry in the same column;
determining second entries, wherein the second entries are the entries in the columns of the first entries and in the rows of the main diagonals associated with the first entries; and
selecting the first entries, the second entries, the symmetrical entries in the respective mirrored secondary diagonals, and the entries on the main diagonal and setting the remaining entries in the columns and rows of the first entries, the second entries, and the entries assigned to the first entries on the main diagonal to zero,
wherein further blocks are formed from the entries that are not zero, and
wherein the preceding steps are repeated for each of these blocks.

3. The computer-implemented method according to claim 1, wherein mᵢ is determined dynamically, wherein mᵢ is initially 2, and, wherein mᵢ is determined by:
determining a largest entry of the secondary diagonals;
determining the row y of the symmetrical input matrix in which the largest entry is located; and
determining a next smaller entry within row y from the secondary diagonals and increasing mᵢ by 1 for each next smaller entry in row y that fulfills a criterion for a strength of the correlation.

4. The computer-implemented method according to claim 1, wherein mᵢ is less than or equal to a defined limit block size.

5. The computer-implemented method according to claim 1, wherein:
the symmetrical input matrix is associated with a system state having a plurality of parameters and the system state is based on a physical model,
the physical model describes a physical correlation between the parameters, and
mᵢ is determined according to the physical correlation between the parameters.

6. A computer-implemented method for determining a Kalman gain for a Kalman filter, comprising:
inverting at least one n×n matrix,
wherein the at least one n×n matrix is inverted as a symmetrical input matrix according to the method of claim 1.

7. The computer-implemented method according to claim 6, wherein:
the entries of the main diagonals of the symmetrical input matrix are each associated with a system state of a technical system,
each column comprises a different system parameter, and
the entries in the secondary diagonals quantify a correlation between system parameters associated with the entries of the main diagonals in the respective row and the respective column.

8. The computer-implemented method according to claim 7, wherein the Kalman filter is used to estimate a behavior of the system parameters and/or a future system state.

9. The computer-implemented method according to claim 7, wherein the system state is a state of a vehicle, a position sensor, an inertial sensor, or an ultrasonic sensor.

10. The computer-implemented method according to claim 6, wherein entries of the symmetrical input matrix contain a correlation between two measured values from two time series, each of which was recorded by a sensor.

11. The computer-implemented method according to claim 6, wherein a computer program comprises program code for performing at least portions of the method when the computer program is executed on a computer.

12. A non-transitory computer-readable data carrier comprising the program code of the computer program of claim 11.

13. A system for determining a Kalman gain for a Kalman filter, wherein the system is configured to perform the method of claim 6.
